(19) United States
(12) Patent Application Publication
(10) Pub. No.: US 2011/0143768 A1
(43) Pub. Date: Jun. 16, 2011

(54) METHODS AND APPARATUS RELATED TO REGION-SPECIFIC MOBILE DEVICE AND INFRASTRUCTURE DETECTION, ANALYSIS AND DISPLAY

(76) Inventors: Sean L. Lane, Sykesville, MD (US); Alexander C. Watson, Severn, MD (US); Stuart M. Gott, Riva, MD (US)

(21) Appl. No.: 12/637,502

(22) Filed: Dec. 14, 2009

(51) Int. Cl. H04W 24/00

(52) U.S. Cl. 455/456.1

(57) ABSTRACT

A processor-readable medium stores code representing instructions to cause a processor to receive a signal including an identifier associated with a wireless base station. The code further represents instructions to cause the processor to determine a geolocation associated with the wireless base station and to receive a signal including an identifier associated with a device operatively coupled to the wireless base station. The code further represents instructions to cause the processor to send a signal including the identifier associated with the wireless base station, the identifier associated with the device and the geolocation.

### BACKGROUND

Embodiments described herein relate generally to mobile device and infrastructure detection and more particularly to mobile device and base station detection, analysis and reporting.

Mobile communication devices such as cellular telephones and computer devices equipped with wireless networking hardware generally exchange information across networks by first connecting to a local base station. For example, cellular telephones typically communicate with a nearby cellular tower to interact with a broader cellular network, and wireless networking devices generally connect to a nearby wireless routing device so as to access a local area network or the Internet. Thus, the vast majority of information exchanged by mobile devices physically situated within a particular geographic region passes through such base stations.

Organizations and individuals often seek an improved understanding of the current status and recent history of mobile telecommunications within a specified region. Such an understanding could facilitate improved wireless network design, allow for finer tracking of individual devices, and discovery of usage patterns across networks and locations.

Known tools can survey, for example, surrounding wireless networking base stations to determine the availability of WiFi “HotSpots” within range of a mobile client device. These tools, however, provide an incomplete picture of the infrastructure and communications transmitted in a given area. Thus, a need exists for a system capable of presenting a comprehensive view of both mobile devices and base stations within a specified location and across all major communications protocols, along with the geolocation of and information transmitted by each. A need further exists for a system capable of providing analytics related to the use of mobile devices and base stations within a specified region.

### SUMMARY

A processor-readable medium stores code representing instructions to cause a processor to receive a signal including an identifier associated with a wireless base station. The code further represents instructions to cause the processor to determine a geolocation associated with the wireless base station and to receive a signal including an identifier associated with a device operatively coupled to the wireless base station. The code further represents instructions to cause the processor to send a signal including the identifier associated with the wireless base station, the identifier associated with the device and the geolocation.

### BRIEF DESCRIPTION OF THE DRAWINGS

FIG. 1 is a schematic illustration of a mobile detection device and a client device, each coupled to a network, a network server including an analytics module, and a database, according to an embodiment.

FIG. 2 is a schematic illustration of a mobile detection device configured to receive information associated with a wireless base station and devices connected thereto, according to another embodiment.

FIG. 3 is a schematic illustration of a mobile detection device, according to another embodiment.

FIG. 4 is a diagram that illustrates a mobile infrastructure map screen, according to another embodiment.

FIG. 5 is a tabular diagram that illustrates a wireless base station database and a device database, according to another embodiment.

FIG. 6 is a flowchart that illustrates a method for surveying the mobile device and base station infrastructure of an area and sending associated information to a client device for rendering on a map, according to another embodiment.

### DETAILED DESCRIPTION

In some embodiments of the invention disclosed herein, a mobile detection device detects information associated with at least one wireless base station physically located in a desired region. The information can include, for example, name and identification information, compatible communication protocols, identification of devices connected to the wireless base station, and the like. The wireless base station can be, for example, a cellular network base station or a wireless networking base station, and devices connected thereto can be, for example, cellular telephones, laptop computers, and the like.

The mobile detection device can be configured to determine a geolocation of a wireless base station based on a signal received from the base station, a geolocation of the detection device itself, or by using other known geolocation algorithms and/or techniques. The mobile detection device can be further configured to send a signal to another device, such as a network server, that includes the detected information. The server can then optionally perform additional analysis on the received information, such as geolocation refinement, trend and/or pattern detection, etc. The server can be further configured to then send the received information to a database for storage.

The mobile detection device can be physically located in or near a hostile environment such as a battlefield, a police perimeter, etc. The mobile detection device can also be used in concert with additional detection devices so as to provide information sufficient to form a comprehensive view and/or report of mobile communications taking place within a particular region.

In some embodiments, the mobile detection device can be configured to “jam” a target wireless device using a noise signal such that the target device ceases communication with a target wireless base station. The mobile detection device can mimic the wireless base station such that the target device is “tricked” into communicating with the mobile detection device. In some embodiments, the mobile detection device can be configured to send a signal to the target device to cause the target device to perform at least one operation or execute at least one instruction such that the target device can be more easily located by, for example, a search party. For example, in some embodiments, the mobile detection device can send a signal to the target device that causes the target device to emit a specified frequency or, for example, to send a message. In some embodiments of the invention, the mobile detection device and/or the server can perform voice or other analysis on communication content associated with the target device.

The server mentioned above can be operatively coupled to a mobile detection device via a network. In some embodiments, the server can be operatively coupled to multiple mobile detection devices via the network. The server can receive information collected by the mobile detection device, such as an identifier associated with a wireless base station, an identifier associated with a device associated with the wireless base station, and/or a geolocation associated with the wireless base station.

As mentioned above, the server can be further configured to perform one or more analytical tasks based at least in part on information received from a mobile detection device, such as information regarding a wireless base station. In performing the analytical tasks, the server can optionally employ other, previously-received information associated with the same or other wireless base stations located in the same geographic region. The analytical tasks can include, for example, discovering trends or patterns in the information, such as the physical movement over time of a particular mobile device or group of devices, communication content trends, and the like.

The server can optionally be configured to receive, from a client device, a signal including a location indicator. The server can then retrieve, from a database, existing wireless base station and device information associated with the location indicator. The server can be configured to then use the retrieved information to define layout information based at least in part on the geolocation and the location indicator. The layout information can include map information sufficient to allow a client device to render a map view of the specified region, overlaid with information associated with one or more wireless base stations and/or devices physically located in that region. The server can then send the layout information to the requesting client device in substantially real-time for display on an output device, such as a screen. The server can optionally be configured to provide updated layout information upon request from a client device, automatically at set intervals, or programmatically whenever underlying information changes or is updated.

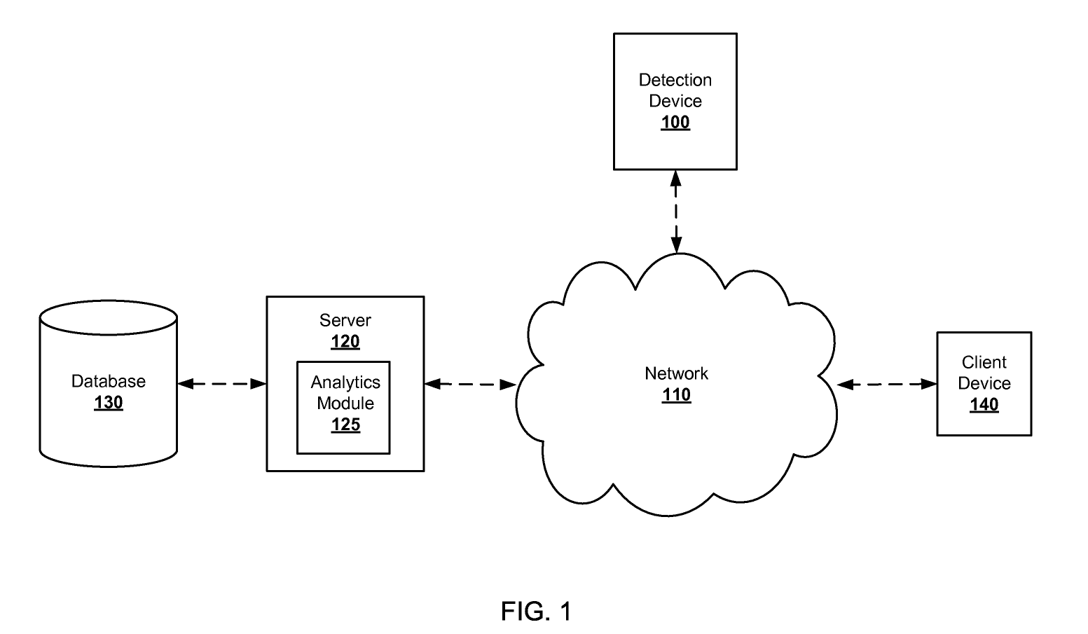

FIG. 1 is a schematic illustration of a mobile detection device and a client device, each coupled to a network, a network server including an analytics module, and a database, according to an embodiment. More specifically, FIG. 1 illustrates a mobile detection device 100 configured to detect information associated with mobile network devices and transmit the detected information via a network 110 for processing by a server 120. The server 120 includes an analytics module 125 and transmits the detected information to a database 130 for storage and subsequent delivery via the network to a client device 140. Mobile detection device 100 can be, for example, a hardware-based module (e.g., a processor, an application-specific integrated circuit (ASIC), a field programmable gate array (FPGA)). Mobile detection device 100 alternatively can also be a software-based module residing on a hardware device (e.g., a processor) or in a memory (e.g., a RAM, a ROM, a hard disk drive, an optical drive, other removable media) operatively coupled to a processor. Although not shown in FIG. 1, in some embodiments, mobile detection device 100 can include one or more wireless antennas designed to send and receive data packets formatted according to a protocol such as Global System for Mobile (GSM), GSM/General Packet Radio Service (GPRS), GSM Enhanced Data Rates for GSM Evolution (EDGE), Code Division Multiple Access (CDMA), CDMA2000, WCDMA (Wideband CDMA), IEEE 802.11x, 802.16x, Long Term Evolution (LTE), and/or the like.

The network 110 can be, for example, a local area network, a wide area network, or the Internet. Although not shown in FIG. 1, in some embodiments the network 110 can include a satellite uplink and/or fiber-optic backhaul to allow communication across large distances, such as those implicated when operating in a remote location or a hostile environment away from more substantial processing capabilities. In some embodiments, the network 110 can be an existing wireless communication network, such as a network to which a target device is currently connected. In some embodiments, the network can be an ad-hoc or overlay network, such as a mobile mesh or other network. In some embodiments, the network 110 can be comprised at least in part of one or more server devices, sub-networks, and the like.

The server 120 can be, for example, a web server or other device capable of exchanging information with mobile detection device 100 and the client device 140 via the network 110. The analytics module 125 can be a software-based module residing on a hardware device (e.g., a processor) or in a memory (e.g., a RAM, a ROM, a hard disk drive, an optical drive, other removable media) operatively coupled to a processor (such as a processor included in or coupled to server 120). Alternatively, in some embodiments analytics module 125 can be, for example, a hardware-based module (e.g., a processor, an application-specific integrated circuit (ASIC), a field programmable gate array (FPGA)) physically or operatively coupled to server 120.

The database 130 could be, for example, a software-based database residing on a hardware device (e.g., a processor) or in a memory (e.g., a RAM, a ROM, a hard disk drive, an optical drive, other removable media) operatively coupled to a processor. In some embodiments, the database 130 can be coupled to the server 120 via a physical connection. In some embodiments, the database 130 can be operatively coupled to the server 120 via a networking protocol. Client device 140 can be, for example, a hardware-based module (e.g., a processor, an application-specific integrated circuit (ASIC), a field programmable gate array (FPGA)). Client device 140 could also be a software-based module residing on a hardware device (e.g., a processor) or in a memory (e.g., a RAM, a ROM, a hard disk drive, an optical drive, other removable media) operatively coupled to a processor. In some embodiments, client device 140 can include a visual display configured to provide image, video, and/or audio content to a user.

Mobile detection device 100 can be configured to collect information associated with one or more mobile devices and/or wireless base stations (not shown) physically located within the operating range of the mobile detection device 100. In some embodiments, the collected information can include credential, physical location and/or communication content information associated with, for example, one or more cellular telephones, cellular tower base stations, computerized wireless networking devices, wireless routers, or other mobile devices. Mobile detection device 100 can be configured to send at least one signal including at least a portion of the collected information to the server 120 via the network 110.

The server 120 can be configured to receive the at least one signal from mobile detection device 100 via the network 110. The server 120 can be further configured to send at least a portion of the collected information included in the at least one signal to the database 130 for storage in, for example, one or more relational database tables.

In some embodiments, server 120 can be configured to use analytics module 125 to perform analytics and/or calculations based at least in part on the collected information. For example, analytics module 125 could be configured to detect communication and/or movement patterns associated with a particular mobile device so as to track the activity of a targeted individual associated with the mobile device over time. In some embodiments, analytics module 125 can be configured to track the proliferation of wireless base stations and/or mobile device presence and activity in a particular region or sub-region over time, so as to detect increased or decreased levels of mobile communications indicative of population or population density growth, suspicious activity, arrival or departure of a target individual or group from a particular geographic location, etc. In some embodiments, analytics module 125 can be configured to apply one or more threshold measurements to derived statistics based on the collected information, and accordingly send signals to a device (such as client device 140) or insert a database value (to, for example, database 130) when the module detects that a certain predefined threshold has been crossed in the collected information. For example, analytics module 125 can be configured to send an alert when a predetermined amount of wireless communication in a region are present within a specified sub-region, or when a preselected mobile device ID (such as a MAC address or cellular telephone number) first appears within the collected information for a given region.

The server 120 can be further configured to receive a request from the client device 140 via the network 110. In some embodiments, the server can receive the request via a second network (not shown). The server 120 can be configured to then send a database request to the database 130, which can be configured to send a response to the server 120 that includes the requested information. The server 120 can be further configured to send a response to client device 140 via network 110. In some embodiments, the response can include physical location, credential and communication information associated with one or more mobile devices or wireless base stations associated with a specified region. In some embodiments, the response can include additional information associated with the physical location, credential and communication information, such as results associated with analysis similar to the analytical tasks described above. In some embodiments, the client device 140 can be configured to receive the response via the network 110 and display at least a portion of the information in graphical or map form for viewing by a user.

The database 130 can be included in a database residing oh the same hardware device as the server 120. In some embodiments, the database can be included in a database residing on a second hardware device different from the server 120. In such embodiments, database 130 can be in communication with server 120 via, for example, a wireless or wired connection and/or via a network (not shown).

The client device 140 can send a request to server 120 via the network 110. In some embodiments, the request can include a request for information associated with wireless base stations and/or mobile devices physically located in or near a specified region. In some embodiments, the request can include a request for one or more analytical task results associated with mobile communications infrastructure and/or a particular mobile device associated with the specified region. In some embodiments, client device 140 can be configured to receive a response from server 120 via network 110. In such embodiments, client device 140 can be configured to format information included in the response for graphical or audible delivery. In some embodiments, the formatting can include plotting of wireless base stations and/or mobile devices onto a map of the specified region.

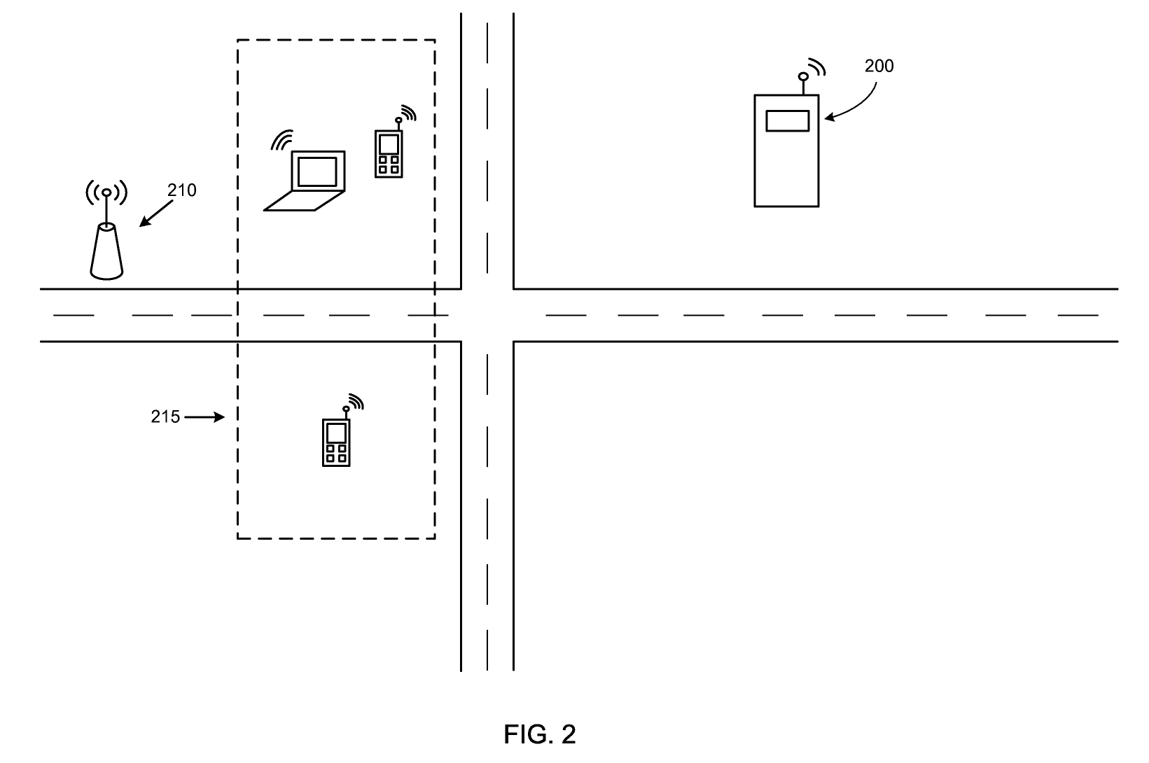

FIG. 2 is a schematic illustration of a mobile detection device configured to receive information associated with a wireless base station and devices connected thereto, according to another embodiment. More specifically, FIG. 2 illustrates a mobile detection device 200 configured to collect information associated with a wireless base station 210 and connected wireless devices 215.

Mobile detection device 200 can be, for example, a hardware-based module (e.g., a processor, an application-specific integrated circuit (ASIC), a field programmable gate array (FPGA)). For example, in some embodiments, mobile detection device 200 can be a personal digital assistant (PDA), a smartphone, a notebook or netbook computer, a digital audio player (DAP), or other portable or handheld computerized device. In some embodiments, mobile detection device 200 can be a software-based module residing on a hardware device (e.g., a processor) or in a memory (e.g., a RAM, a ROM, a hard disk drive, an optical drive, other removable media) operatively coupled to a processor. For example, in some embodiments mobile detection device 200 can be a software program or “app” configured to be executed on a handheld device such as a smartphone, a wrist computer, or other portable computing device such as a PDA or notebook computer. In some embodiments, mobile detection device 200 can be similar to or included in a distributed mobile architecture server shown and described in U.S. Pat. No. 7,486,967 to Pan, filed Nov. 8, 2004, and entitled “System, Method and Device for Providing Communications Using a Distributed Mobile Architecture”; U.S. Pat. No. 7,539,158 to Pan, filed Nov. 8, 2004, and entitled “System, Method and Device for Providing Communications Using a Distributed Mobile Architecture”; and/or U.S. Pat. No. 7,548,763 to Pan, filed Apr. 13, 2005, and entitled “System, Method and Device for Providing Communications Using a Distributed Mobile Architecture,” each of which is incorporated herein by reference in its entirety.

In some embodiments, mobile detection device 200 can be carried within or on a vehicle, such as a motorized vehicle, to allow for surveying of entire geographic regions or zones. For example, in some embodiments, the mobile detection device can be coupled to an automotive vehicle such as a truck or to an autonomous vehicle such as a drone aircraft or land-based robotic device. In some embodiments, the mobile detection device could be coupled to an object situated so as to go unnoticed by passersby, such as a rock or other typical element of an urban or rural landscape. In some embodiments, one or more mobile detection devices 200 can be employed by individuals, such as soldiers, for detecting wireless infrastructure and device information in a hostile environment. In such embodiments, a soldier can carry a mobile detection device 200 as part of a uniform or, for example, in a backpack.

Wireless base station 210 can be, for example, a base station associated with a cellular voice and/or data network (not shown), such as a GPRS, EVDO, GSM, CDMA, or LTE cellular network. Alternatively, wireless base station 210 can be, for example, a wireless router, access point, wireless repeater, switch, or other device or node configured to define or participate as part of a wireless computer network, such as a wireless network through which data is exchanged according to an IEEE 802.11 or WiMax standard. In some embodiments, wireless base station 220 can be any other type of wireless communication base station, such as a base station associated with the Bluetooth, wireless USB, or Ultra Wide Band (UWB) standards. In still other embodiments, wireless base station 210 can be similar to or included in one or more distributed mobile architecture servers as described and shown in U.S. Pat. No. 7,486,967 to Pan, filed Nov. 8, 2004, and entitled “System, Method and Device for Providing Communications Using a Distributed Mobile Architecture”; U.S. Pat. No. 7,539,158 to Pan, filed Nov. 8, 2004, and entitled “System, Method and Device for Providing Communications Using a Distributed Mobile Architecture”; and/or U.S. Pat. No. 7,548,763 to Pan, filed Apr. 13, 2005, and entitled “System, Method and Device for Providing Communications Using a Distributed Mobile Architecture,” each of which is incorporated herein by reference in its entirety. In some such embodiments, mobile detection device 200 and wireless base station 210 can be included in a single device, such as a distributed mobile architecture server.

Connected wireless devices 215 can be, for example, one or more hardware devices configured to transmit information across a cellular network, such as a cellular telephone, a computerized device equipped with a cellular “air” card, or other device. Alternatively, connected wireless devices 215 can be, for example, one or more hardware devices configured to exchange information via a wireless computer network, such as a laptop or desktop computer, a personal digital assistant (PDA), a smartphone, a video game system, or other device. In some embodiments, the group of connected wireless devices 215 can include one or more devices capable of exchanging information using another radio wave-based protocol such as Bluetooth, wireless High Definition Multimedia Interface (HDMI), Ultra Wide Band (UWB), wireless Universal Serial Bus (USB), Radio Frequency Identification (RFID), and the like.

Mobile detection device 200 can be configured to scan the wireless spectrum to detect the presence of one or more nearby wireless base stations such as wireless base station 210. In some embodiments, mobile detection device 200 can be configured to determine one or more attributes associated with wireless base station 210, such as a name or identifier, a list of compatible communication protocols, etc. In some embodiments, the name or identifier could be a Service Set Identifier (SSID) associated with a wireless local area computer network (LAN) or other credential used to identify wireless base station 210 on a cellular network.

In some embodiments, mobile detection device 200 can include a Global Positioning Satellite (GPS) module, which can be configured to determine its current physical location, and to calculate a geolocation for wireless base station 210. In some embodiments, the GPS module (not shown) can be at least one hardware and/or software module operatively coupled to the mobile detection device 200. In some embodiments, the calculation can be based at least in part on a current geolocation of the mobile detection device itself and/or a signal strength and/or angle of reception of at least one signal received from wireless base station 210. In some embodiments, the calculation can be based on at least one of the following techniques: GSM localization, Assisted-GPS, Cell Identification, Enhanced Cell Identification, Uplink-Time difference of arrival (U-TDOA), multilateration, triangulation, or other methods of determining a geographic location of a hardware device. In some embodiments, mobile detection device 200 can include at least one third-party and/or proprietary hardware and/or software module configured to determine an angle of reception and/or signal strength of the at least one signal received from the wireless base station 210. In some embodiments, mobile detection device 200 can be physically located on or within a motorized or other moving vehicle. In such embodiments, mobile detection device 200 can include at least one hardware and/or software module configured to account for movement of the mobile detection device 200 when calculating the geolocation based on a multilateration, triangulation or similar technique.

In some embodiments, mobile detection device 200 can be configured to detect information associated with one or more devices from connected wireless devices 215. For example, mobile detection device 200 can be configured to detect a wireless device type, wireless device model name, wireless device identifier or other information associated with one or more of the connected wireless devices 215. In some embodiments, mobile detection device 200 can be configured to detect, for example, a Media Access Control (MAC) address associated with a wireless networking device or a cellular telephone number associated with a cellular device that is part of the connected wireless devices 215.

In some embodiments, mobile detection device 200 can be configured to collect information associated with a connected device by mimicking or “spoofing” the credentials of wireless base station 210. For example, in some embodiments mobile detection device 200 can include one or more wireless antennas capable of emitting signals including credential information obtained during a wireless base station detection process (as described above). In some embodiments, mobile detection device 200 can be configured to first send a noise signal on a frequency currently used by a target connected device from the connected wireless devices 215 in its communications with the wireless base station 210. In such embodiments, the noise signal can be configured to cause the connected device to cease communication with the wireless base station 210. In such embodiments, mobile detection device 200 can be configured to then emit a subsequent signal including credentials associated with wireless base station 210. In such embodiments, the signal can be transmitted to the target connected device such that the target connected device commences communication with mobile detection device 200. During this communication process, mobile detection device 200 can, for example, obtain the mobile device information detailed above. In still other embodiments, mobile detection device 200 can be configured to collect information associated with a connected device by performing a wireless base station mimicking method similar to the mimicking method shown and described in U.S. Patent Publication No. 2008/0146158A1 to PAN et al.

In some embodiments, mobile detection device 200 could be configured to send one or more instructions to a connected wireless device from connected wireless devices 215. For example, in some embodiments the mobile detection device could be configured to send an instruction to cause the connected device to emit a radio signal on a specified frequency for use in determining an exact physical location of that connected device.

In some embodiments, mobile detection device 200 can be further configured to capture the content of communications sent to and from the connected wireless devices 215 for subsequent analysis by the mobile detection device or at a server (not shown). In some embodiments, mobile detection device 200 can be further configured to detect the presence of a particular voice or other sound pattern in the communications content. In some embodiments, the mobile detection device can send a signal including an alert or indicator that the voice or sound pattern was detected, along with, for example, at least one of: a time of detection indicator, an identity of the mobile device from which the sound pattern was transmitted, an identity of the wireless base station through which the sound pattern was transmitted, a physical location of the wireless base station, etc. In some embodiments, mobile detection device 200 can be further configured to send a signal to a local or remote server for voice analysis of the communications content.

In some embodiments, mobile detection device 200 can be further configured to calculate a geolocation for one or more of the connected wireless devices 215. In some embodiments, the mobile detection device can be configured to base the calculation on at least one of: a current geolocation of the mobile detection device, a signal strength of one or more signals received from connected wireless device, triangulation techniques, or other method of determining a geographic location of a hardware device.

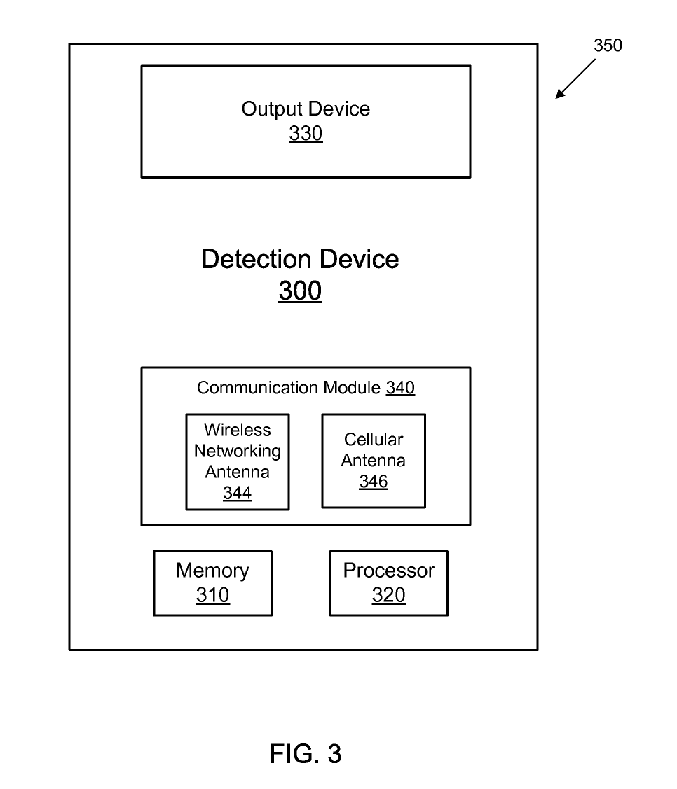

FIG. 3 is a schematic illustration of a mobile detection device, according to another embodiment. Specifically, FIG. 3 illustrates a detection device 300 that includes a memory 310, a processor 320, an output device 330, and a communication module 340 disposed within a housing 350. In the particular embodiment illustrated by FIG. 3, communication module 340 includes a wireless networking antenna 344 and a cellular antenna 346. In some embodiments, one or more of memory 310, processor 320, output device 330, and/or communication module 340 can optionally be located in a second housing (not shown) physically and/or wirelessly coupled to processor 320 and/or communication module 340. In some embodiments, housing 350 can be a rubberized housing or other housing designed for use in rugged terrain and/or conditions, such as a rural setting or a military setting.

Memory 310 can be any suitable computer memory. For example, the memory can be random-access memory (RAM), read-only memory (ROM), flash memory, erasable programmable read-only memory (EPROM), electrically erasable programmable read-only memory (EEPROM), and/or other suitable memory. In some embodiments, memory 310 can be configured to store code representing processor instructions and/or data received from communication module 340.

Processor 320 can be any suitable processor capable of executing computer instructions and of receiving data from communication module 340. In some embodiments, processor 320 can be a microcontroller, a field-programmable gate array (FPGA), an application specific integrated circuit (ASIC), and/or any other suitable processor.

Output device 330 can be any suitable electronic display. For example, output device 330 can be a liquid crystal display (LCD), a series of light-emitting diodes (LEDs), a series of organic light-emitting diodes (OLEDs), an electronic ink display, or other device employing suitable display technology. In yet other embodiments, detection device 300 does not include a display. In such embodiments, instead of and/or in addition to a display, detection device 300 can include a speaker, a haptic indicator (e.g., a vibration device) and/or any other output device configured to convey information to a user.

Communication module 340 can be any suitable combination of hardware and/or software configured to allow for transmission and receipt of wireless signals such as, for example, wireless networking and/or cellular network signals. In some embodiments, communication module 340 can include at least one of a wireless networking antenna or a cellular antenna, such as wireless networking antenna 344 and cellular antenna 346. In some embodiments, communication module 340 can include an internal wireless networking radio coupled to a wireless networking hardware module, such as an internal wireless networking network interface card/controller (NIC) (not shown).

In some embodiments, communication module 340 can be further configured to use wireless networking antenna 344 to exchange information formatted according to an IEEE 802.11 standard and/or at least one other standard, such as WiMax. In some embodiments, communication module 340 can be further configured to use cellular antenna 346 to exchange information formatted according to a cellular networking standard such as GPRS, GSM, EVDO, CDMA, or LTE.

In some embodiments, communication module 340 can include multiple wireless antennas configured to detect the presence of wireless networking and/or cellular network devices, to emulate a wireless networking base station and/or a cellular base station, and/or to transmit collected information across a network for storage at a server (not shown), as discussed, for example, in connection with FIG. 1. In some embodiments, wireless networking antenna 344 and/or cellular antenna 346 can be disposed within housing 350. In other embodiments, wireless networking antenna 344 and/or cellular antenna 346 can be coupled to housing 350 via a physical connection such as a cable.

In some embodiments, communication module 340 can be configured to detect the presence of wireless networking and/or cellular base stations located within physical proximity of the detection device 300. For example, communication module 340 can be configured to scan a specified frequency range for signals associated with a wireless networking and/or cellular base station (not shown) within operating range of wireless networking antenna 344 and/or cellular antenna 346. In some embodiments, such signals can include credential information associated with a wireless networking base station, such as an SSID, encryption type, networking protocol, etc. In some embodiments, such signals can include credential information associated with the cellular base station, such as a base station ID, cellular network protocol, etc. In some embodiments, communication module 340 can transmit the signals to processor 320 for processing and storage to memory 310.

In some embodiments, communication module 340 can be configured to send signals configured to mimic a detected wireless networking or cellular base station so as to initiate communication with a connected wireless networking or cellular device for data collection purposes. In some embodiments, communication module 340 can be configured to receive wireless communication signals associated with a connected device, including the content of communication signals intended for delivery to another local or remote wireless networking or cellular device. In such embodiments, communication module 340 can be configured to send content extracted from or information associated with the communication signals to processor 320 for subsequent storage at memory 310.

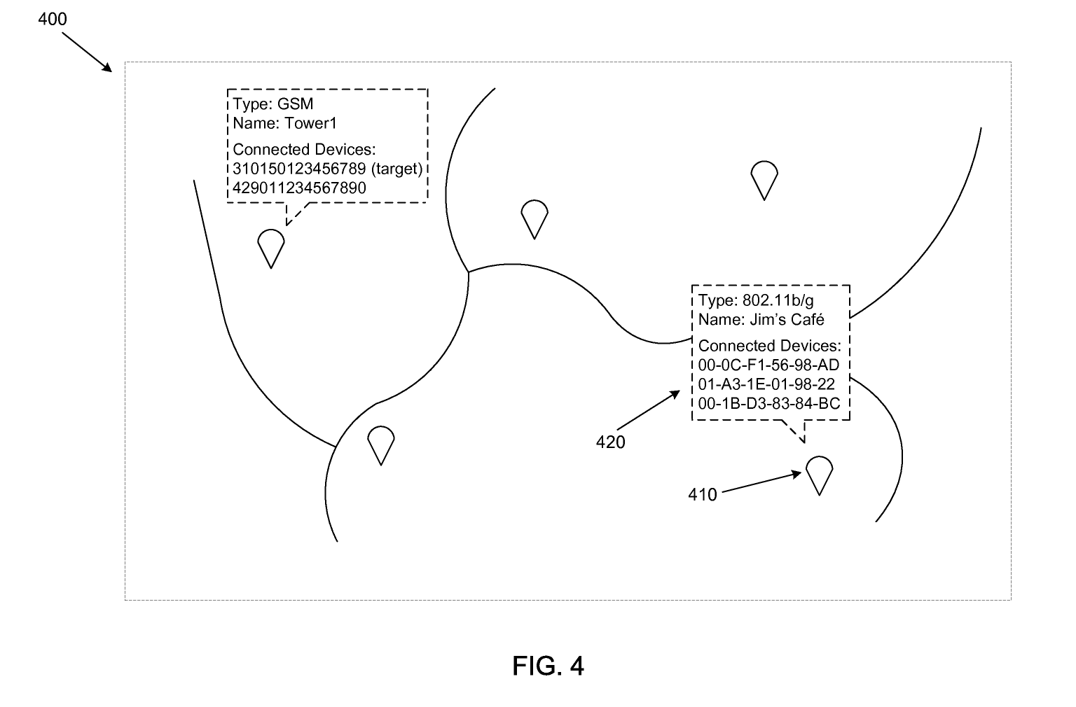

FIG. 4 is a diagram that illustrates a mobile infrastructure map screen, according to another embodiment. More specifically, FIG. 4 illustrates a graphical representation of a map 400 that includes a base station location indicator 410 and a base station information box 420 displayed on an output device (not shown).

Map 400 can be any suitable graphical representation of a specified region or area, such as a topographical map, a road map, a satellite image-based map, or other combination of visual elements configured to represent a specified geographic region. In some embodiments, map 400 could be rendered in a two-dimensional (2-D) or three-dimensional (3-D) format.

Base station location indicator 410 can be any suitable graphical element configured to indicate the presence of a base station at a particular position on map 400. In some embodiments, the base station location indicator can be, for example, an arrow, push-pin icon, geometric shape, photorealistic image, or other graphical indicator. In some embodiments, base station location indicator 410 can optionally be or include an audio or tactile indicator.

Base station information box 420 can be any suitable grouping of text and or symbols sufficient to represent collected information associated with a base station. For example, in some embodiments base station information box 420 could be a text field or box that includes information such as a base station identifier, a base station latitude and longitude coordinates, a base station type, communication protocols with which the base station is compatible, and/or information associated with one or more mobile devices currently or recently associated with the base station. In some embodiments, base station information box 420 can include one or more moving graphics configured to convey at least a portion of the above information and/or other information or functionality.

In some embodiments, map 400 can include graphical and/or textual indicators associated with one or more wireless base stations physically located within the geographic area represented by the map, such as wireless networking base stations and/or cellular network base stations. In some embodiments the indicators can include one more base station location indicators such as base station location indicator 410. In some embodiments, base station location indicator 410 can be configured to provide additional information and/or functionality when selected by a user. For example, in some embodiments, base station location indicator 410 can be configured to offer further information, such as the information included in base station information box 420.

In some embodiments, code representing instructions to cause a processor to generate map 400 can additionally send an alert or other audio signal to an audio playback device, such as a speaker, upon user selection of a given graphical element situated on map 400. In some embodiments, map 400 can include graphical representations of at least one mobile detection device (not shown), each such representation being situated on the map 400 based on a current physical location of that mobile detection device. In some embodiments, the code representing instructions to cause a processor to generate map 400 can include code to cause a processor to render further information related to the mobile detection device on the output device in response to a user selection or input, the further information overlaying at least a portion of the map.

In some embodiments, map 400 can be configured to include information that is substantially “real-time”, i.e. information that reflects the most-recent positions of and information associated with wireless base stations detected in the map's represented region. In some embodiments map 400 can be generated by processor instructions situated at or received by a client device (not shown), such as client device 140 discussed in connection with FIG. 1 above. In such embodiments, these instructions can include, for example, instructions sufficient to cause a processor included in the client device to render map 400 on an output device. In some embodiments, these instructions can further include instructions sufficient to cause the processor to refresh the map on demand, at a regular time interval, or in response to the acquisition of new information, such that the map contains substantially “real-time” information.

In some embodiments, map 400 can be generated by processor instructions sufficient to allow a user to view a version of map 400 that represents information current as of a specified time period, date, or date range. In some embodiments, these instructions could include instructions to cause a processor to render the changing locations of various mobile communication elements in the region over time, the rendering being an animation, movie clip, or other temporally based presentation format.

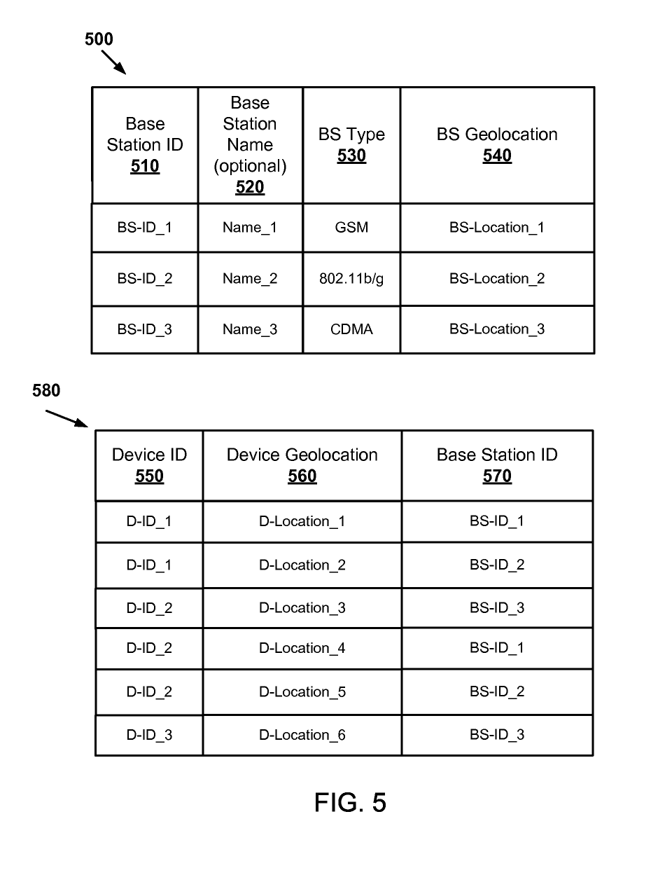

FIG. 5 is a tabular diagram that illustrates examples of a wireless base station database and a device database, according to another embodiment. As shown in FIG. 5, wireless base station database 500 can include one or more records associated with a detected wireless base station. Each record in wireless base station 500 can include a base station ID (column 510) with an optional corresponding base station name (column 520). As further shown in FIG. 5, a wireless base station ID can have a corresponding base station type (column 530) and corresponding approximate geolocation for the wireless base station (column 540). In some embodiments, wireless base station database 500 could optionally include a column (not shown) that includes additional information associated with the corresponding wireless base station ID, such as a general region of operation, whether the base station has been compromised (i.e., accessed to extract additional information), or other miscellaneous notes associated with that base station.

As also shown in FIG. 5, device database 580 can include one or more records associated with a detected mobile device associated with or connected to one or more detected wireless base stations. Each record in device database 580 can include a device ID (column 550), a device geolocation (column 560) and an associated base station ID (570).

In some embodiments, base station ID (column 510) could be a self-assigned base station identifier, such as an SSID associated with a wireless networking router or access point. In some embodiments, the base station ID could be an identifier assigned by a user, automatically generated by a mobile detection device (not shown), or automatically generated by processing instructions associated with wireless base station database 500 executed at the time of record insertion/creation.

In some embodiments, the base station name (column 520) can be a name or other textual identifier associated with a detected base station. For example, the base station name could be a textual label emitted by the base station itself, or alternatively, an identifier assigned by an information collection server such as server 120 discussed in connection with FIG. 1 above.

In some embodiments, base station type (column 530) could be a cellular base station type, such as a GPRS, GSM, EVDO, CDMA, or LTE cellular antenna or base station. In some embodiments, the base station type could be a wireless networking base station type, such as an 802.11a/b, 802.11g, 802.11n or WiMax. In some embodiments, base station geolocation (column 540) can be one or more geographic coordinates, such as latitude and longitude coordinates. In some embodiments, the base station geolocation can be calculated based at least in part on a GPS position of a detecting device (not shown) as discussed in connection with FIG. 3 above.

In some embodiments, device ID 550 could be a self-assigned or predefined identifier, such as a cellular telephone number associated with a cellular telephone or a MAC address associated with a wireless networking card included in a laptop computer. In some embodiments, the device ID could be an identifier assigned by a user, by a mobile detection device (not shown), or by processing instructions associated with device database 580.

In some embodiments, wireless base station database 500 and mobile device database 580 can both be included in a database residing on the same hardware device as a mobile communication analytics module (not shown) such as that discussed above in connection with FIG. 1. In some embodiments, the wireless base station database can be included in a database residing on a second hardware device different from the first hardware device on which the mobile communication analytics module resides, with the first hardware device and the second hardware device configured to communicate over a network. In some embodiments, the wireless base station database 500 can be included in a database residing on a second hardware device different from that on which mobile device database 580 resides, with the devices and databases configured to communicate over a network.

In some embodiments, the wireless base station database 500 can receive values for a base station ID (column 510), a base station name (column 520), a base station type (column 530), and a base station geolocation (column 540). In some embodiments, device database 580 can receive values for a device ID (column 550), a device geolocation (column 560) an associated base station ID (570). In such embodiments, each database can be configured to define a record for each set of the above-identified column values in that database.

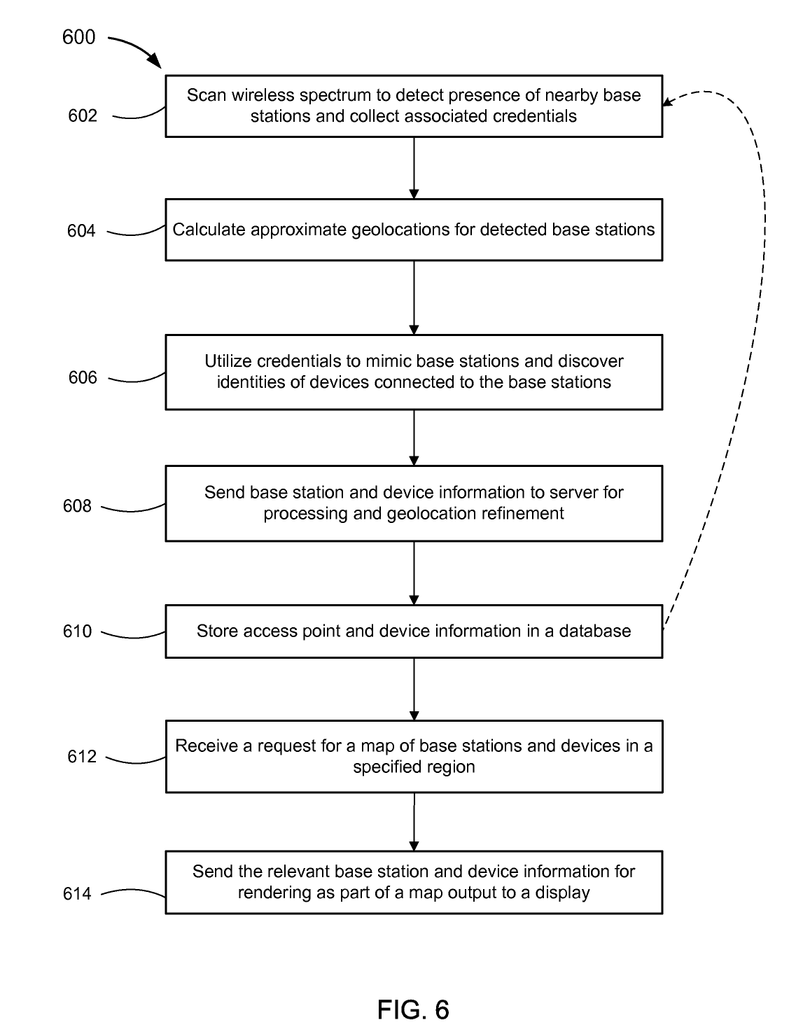

FIG. 6 is a flowchart that illustrates a method for surveying the mobile base station and device infrastructure of an area and sending associated information to a client device for rendering on a map, according to another embodiment. As shown in FIG. 6, a mobile detection device can scan surrounding terrestrial spectrum to discover the presence of nearby wireless base stations and collect associated credentials, 602. The mobile detection device can be, for example, a portable computing device equipped with one or more wireless communication antennas, such as a personal digital assistant (PDA), a laptop, notebook, or netbook computer, a tablet computing device, a cellular telephone or smartphone, or other device capable of collecting information associated with mobile communications devices located within its proximity. In some embodiments, the associated credentials can be, for example, identification credentials, protocol information, and the like.

The mobile detection device can calculate an approximate geolocation for each detected base station, 604. In some embodiments, the calculation for a given detected base station can be based at least in part on a physical location of the mobile detection device at the time when that wireless base station was detected by the device. In some embodiments, the calculation can be further based on a signal strength and/or signal direction of one or more signals received by the mobile detection device from that wireless base station. In some embodiments, the calculation can be further based on one or more signals detected from one or more mobile devices operatively coupled to the wireless base station. In some embodiments, the calculation can be based at least in part on a triangulation and/or other object position calculation techniques.

The mobile detection device can use an acquired wireless base station credential to mimic that base station and discover devices connected thereto, 606. In some embodiments, the mobile detection device can mimic the wireless base station by emitting, via a wireless antenna, signals that intentionally misrepresent the identity of the mobile detection device. In some embodiments, the signals can include an identification indicator associated with the wireless base station. In this manner, mobile devices connected to the wireless base station can be “tricked” into communicating with the mobile detection device under the assumption that the detection device is in fact the wireless base station.

In some embodiments, the mobile detection device can be configured to extract connected mobile device credential information from the communications so as to gather a list of all devices connected to the wireless base station. In some embodiments, the mobile detection device can be further configured to intercept communication packets sent by one or more connected mobile devices for subsequent analysis by the detection device itself, by a computing device connected thereto, or at a remote computerized device such as a server. For example, in some embodiments, the mobile detection device can be configured to send connected device credential information to a server to determine if the device is associated with a known target, such as a known target individual, entity or location. In some embodiments, the mobile detection device can be further configured to intercept communication packet metadata from a connected device such as telephone call source, information packet source, information packet destination, and the like.

The mobile detection device can be configured to send the collected wireless base station credentials, calculated geolocations and connected device information to a server for processing and geolocation refinement, 608. The server can be a computerized device such as a mobile device, a desktop computer, a network server or other device capable of processing computer instructions. The server can be operatively coupled to the mobile detection device via a network. In some embodiments, the server can be physically located far from the mobile detection device, connected or operatively coupled to the detection device via a wide-area network (WAN), satellite uplink, fiber-optic backhaul, or the Internet. Alternatively, in some embodiments, the server can be physically connected to the mobile detection device via a direct cable or other connection.

In some embodiments, the server can be configured to refine the received geolocation calculations by applying additional algorithms and/or averaging a given calculation for a given wireless base station with other, previously-recorded geolocation approximations for that wireless base station. By using such an approach, the server can successively improve the accuracy of wireless base station geolocations over time as it receives additional geolocation calculations from detection devices.

In some embodiments, the server can receive the collected base station information, collected device information, and calculated geolocations and perform processing and/or analytic tasks based thereon. For example, in some embodiments the server can be configured to perform one or more tasks and/or calculations related to the collected information so as to further analytical goals. In some embodiments, the calculations can involve previously-stored information collected by a mobile detection device at an earlier time. For example, the server could be configured to combine mobile device location and communication information to track or map usage and/or movement of a particular mobile device or group of mobile devices over time. In some embodiments, the tasks can further include generating reports, graphs, charts, maps and/or alerts related to the analysis. In some embodiments, the information can be presented to a human analyst for further strategic analysis and decision-making. In some embodiments, one or more reports, graphs, charts, or maps can be sent by the server to one or more field-based analysts and/or actors.

The server can send the collected information and the results of any additional calculations or analytics to a database, 610. The database can be any relational database system or other database stored in software and or hardware and located at a hardware device, such as a database server. In some embodiments, the database can be, for example, a Microsoft Access, Oracle, Microsoft SQL Server, Postgresql, or MySQL database. In some embodiments, the database can be connected to the server via a physical connection. In other embodiments, the database can be operatively coupled to the server via a wired or wireless network connection over a network such as a local area network (LAN), wide area network (WAN), or the Internet. In some embodiments, the server can be configured to send the collected information and analytical results to the database at regular intervals, such as once per hour or day. In some embodiments, the server can be configured to send the information to the database immediately upon reception from the mobile detection device.

In some embodiments, the steps 602 through 610 can be performed iteratively by an individual mobile detection device as it is employed to detect mobile communication infrastructure and devices across multiple regions, or across the same region repeatedly. In some embodiments, the steps can be performed by and in response to multiple mobile detection devices distributed across a larger geographic region, such as a battlefield or region under surveillance. In such an embodiment, each mobile detection device can be configured to communicate with one or more servers similar to the server discussed in connection with FIG. 1 above, each operatively coupled to the database.

The server can receive a request for a map of base stations and devices in a specified region, 612. The request can include a specified location defined by, for example, a postal code, a telephone country or area code, a place name, a political municipality name, latitude and longitude coordinates, etc. In some embodiments, the request can be received at the server from a client device via a network, such as a local area network or the Internet. In some embodiments, the request can be received via hypertext transfer protocol (http), short message service (SMS), voice command, or other information exchange protocol.

The server can retrieve and send the relevant base station and device information for rendering by a display device, 614. In some embodiments, the server can retrieve the information by sending a request to a database in which the information is stored. For example, the server could be configured to send a Structured Query Language (SQL) query statement to a relational database, thereby requesting all wireless base station and connected device information associated with a particular geographic area.

In some embodiments, the server can be configured to then send the received information to the requesting client device for display. In some embodiments, the server can be configured to send the received information to a display device different from the requesting client device. For example, in some embodiments the server could be configured to receive the request from a cellular telephone over SMS or via the Internet, and then send the received information to a display device, such as a laptop computer or networked television.

In some embodiments, the server can be configured to format the received information prior to transmission to the client device. For example, in some embodiments the server can format the retrieved base station and device information in an open map information format, such as a Google Maps, Yahoo! Maps, MapQuest, or other format. In such embodiments, the server can insert additional information along with the formatted, retrieved information, such as information necessary to allow for proper rendering of push-pins, markers, data balloons, and/or other static or interactive map elements by the client device.

In some embodiments, the display device can be configured to render the wireless base station and connected device information on a graphical map, such as the map discussed in connection with FIG. 4 above. The display device can be, for example, a desktop computer, a laptop, notebook or netbook computer, a smartphone or other cellular telephone, a personal digital assistant (PDA), a tablet or slate computing device, a digital audio player (DAP), a networked television, or other device capable of receiving and displaying the information. In some embodiments, the display device can optionally display the information in a list or text format. Such a list may be advantageous when the display device lacks sufficient processing, graphical or resolution technology for rendering an adequate graphical map representation.

As used in this specification, the singular forms “a,” “an” and “the” include plural referents unless the context clearly dictates otherwise. Thus, for example, the term “a module” is intended to mean a single module or a combination of modules.

While various embodiments have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Some embodiments described herein relate to a computer storage product with a computer- or processor-readable medium (also can be referred to as a processor-readable medium) having instructions or computer code thereon for performing various computer-implemented operations. The media and computer code (also can be referred to as code) may be those designed and constructed for the specific purpose or purposes. Examples of computer-readable media include, but are not limited to: magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as general purpose microprocessors, microcontrollers, Application-Specific Integrated Circuits (ASICs), Programmable Logic Devices (PLDs), and Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages (e.g., object-oriented programming languages) and development tools. Additional examples of computer code include, but are not limited to, control signals, encrypted code, and compressed code.

Although various embodiments have been described as having particular features and/or combinations of components, other embodiments are possible having a combination of any features and/or components from any of embodiments where appropriate. For example, while shown and described in FIG. 1 as being connected via the network 110 to a single mobile detection device 100, in other embodiments, the server 120 can be connected to any number of mobile detection devices.

What is claimed is:

1. A processor-readable medium storing code representing instructions to cause a processor to:
receive a signal including an identifier associated with a wireless base station;
determine a geolocation associated with the wireless base station;
receive a signal including an identifier associated with a device operatively coupled to the wireless base station; and
send a signal including the identifier associated with the wireless base station, the geolocation and the identifier associated with the device.

2. The processor-readable medium of claim 1, wherein the determining the geolocation is based at least in part on at least one of:
a current physical location of an hardware module operatively coupled to the processor-readable medium; or
a signal strength of the signal associated with the wireless base station.

3. The processor-readable medium of claim 1, wherein the first signal is formatted according to at least one of:
a wireless networking protocol;
a cellular network protocol; or
a short-range radio communication protocol.

4. The processor-readable medium of claim 1, wherein the geolocation is a first geolocation, the code further comprising code representing instructions configured to cause the processor to:
determine a second geolocation associated with the device based at least in part on a signal strength of the signal associated with the device.

5. The processor-readable medium of claim 1, wherein the geolocation is a first geolocation, the code further comprising code representing instructions to cause a processor to:
determine a second geolocation associated with the wireless base station; and
send a signal including the identifier associated with the wireless base station and the second geolocation.

6. The processor-readable medium of claim 1, the code further comprising code representing instructions configured to cause the processor to:
send a signal including information configured to mimic the wireless base station and instruct the device to send the signal including the identifier associated with the device.

7. The processor-readable medium of claim 1, wherein the signal including the identifier associated with the wireless base station, the geolocation and the identifier associated with the device is sent to a hardware device via a satellite uplink.

8. The processor-readable medium of claim 1, the code further comprising code representing instructions configured to cause the processor to:
receive a signal including an indicator that the device is a target device in response to the signal including the identifier associated with the wireless base station, the geolocation and the identifier associated with the device.

9. A processor-readable medium storing code representing instructions to cause a processor to:
receive a signal from a wireless base station including at least one wireless base station credential;
send a signal to a mobile device, the signal sent to the mobile device including the at least one wireless base station credential and configured to cause the mobile device to commence communication with a communication module coupled to the processor and not the wireless base station; and
receive a signal from the mobile device including at least one mobile device credential.

10. The processor-readable medium of claim 9, the code further comprising code representing instructions configured to cause the processor to:
send a signal to a server including the mobile device credential and configured to cause the server to determine if the mobile device credential is associated with a known target.

11. The processor-readable medium of claim 9, wherein the signal received from the mobile device is a first signal received from the mobile device, the code further comprising code representing instructions configured to cause the processor to:
receive a second signal from the mobile device including at least one of:
communication content;
sent communication destination information; or
received communication source information;

12. The processor-readable medium of claim 9, wherein the signal sent to the mobile device is a first signal sent to the mobile device, the code further comprising code representing instructions configured to cause the processor to:
send a second signal to the mobile device including at least a noise signal configured to cause the mobile device to cease communication with the wireless base station.

13. The processor-readable medium of claim 9 wherein the signal sent to the mobile device is a first signal sent to the mobile device, the code further comprising code representing instructions configured to cause the processor to:
send a second signal to the mobile device configured to cause the mobile device to send a cellular signal at a specified frequency.

14. The processor-readable medium of claim 11, the code further comprising code representing instructions configured to cause the processor to:
send a signal to a server including the communication content and configured to cause the server to perform voice analysis on the communication content.

15. A processor-readable medium storing code representing instructions to cause a processor to:
receive a signal including:
an identifier associated with a wireless base station;
a geolocation associated with the wireless base station; and
an identifier associated with a device associated with the wireless base station;
receive a signal including a location indicator;
determine layout information based at least in part on the geolocation and the location indicator, the layout information configured to enable generation of a visual representation of the wireless base station and the device; and
send a signal including at least:
the identifier associated with the wireless base station;
the identifier associated with the device; or
the layout information.

16. The processor-readable medium of claim 15, the code further comprising code representing instructions configured to cause the processor to:
define a first association between the identifier associated with the wireless base station and the geolocation;
define a second association between the identifier associated with the wireless base station and the identifier associated with the device; and
store the first identifier, the second identifier, the first association, the second association and the geolocation at a memory.

17. The processor-readable medium of claim 15, wherein the geolocation is a first geolocation, the code further comprising code representing instructions configured to cause the processor to:
receive a signal including:
the identifier associated with the wireless base station; and
a second geolocation associated with the wireless base station;
calculate a third geolocation based at least in part on the first geolocation and the second geolocation;
define an association between the third geolocation and the identifier associated with the wireless base station; and
store the association and the third geolocation at a memory.

18. The processor-readable medium of claim 15, wherein the signal associated with the wireless base station is received from a wireless device via a mesh network.

19. The processor-readable medium of claim 15, the code further comprising code representing instructions configured to cause the processor to:
determine a match between the identifier associated with the device and at least one target identifier from a plurality of target identifiers; and
send a signal including an indicator that the device is a target device.

20. The processor-readable medium of claim 15, wherein the layout information enables generation of a visual representation that includes display elements associated with one or more of:
the identifier associated with the wireless base station;
a base station type indicator associated with the wireless base station;
a second location indicator associated with the wireless base station, the second location indicator being based at least in part on the geolocation;
the identifier associated with the device; and
a device type indicator associated with the device.
